(19) United States
(12) Patent Application Publication
(10) Pub. No.: US 2011/0172873 A1
(43) Pub. Date: Jul. 14, 2011

(54) EMOTIVE ADVISORY SYSTEM VEHICLE MAINTENANCE ADVISOR

(75) Inventors: Steven Joseph Szwabowski, Northville, MI (US); Perry Robinson MacNeille, Lathrup Village, MI (US); Christopher John Teslak, Plymouth, MI (US); Oleg Yurievitch Gusikhin, West Bloomfield, MI (US); Dimitar Petrov Filev, Novi, MI (US); Ilya Vladimir Kolmanovsky, Novi, MI (US)

(73) Assignee: FORD GLOBAL TECHNOLOGIES, LLC, Dearborn, MI (US)

(21) Appl. No.: 12/684,533

(22) Filed: Jan. 8, 2010

(51) Int. Cl. G06F 7/00; G10L 21/00

(52) U.S. Cl. 701/30; 704/270; 704/E21.001

(57) ABSTRACT

A vehicle maintenance advisor system for use by a driver of an automotive vehicle includes a computer. The computer is configured to receive input indicative of a vehicle history. The vehicle history includes how the vehicle is driven over time. The computer is further configured to identify a need to advise the driver that the vehicle requires a maintenance service based on the vehicle history. An alert is output to the driver. The alert indicates the required maintenance service for the vehicle.

### BACKGROUND

1. Technical Field

The invention relates to an emotive advisory system (EAS) for use by one or more occupants of an automotive vehicle.

2. Background Art

The vehicle dashboard continues to grow increasingly complex. As new systems are added and existing systems become more complex there is added competition for space on the dashboard and the controls are increasingly difficult to use. New systems include navigation systems, MP3 players, hands free cell phone and satellite radio; while old systems that are becoming more complex are FM/AM radio, HVAC (heat, ventilation and air conditioning), vehicle lighting and drivetrain controls.

Increasingly there is a move away from conventional controls to human interfaces to manage this complexity. In one approach, multiple interfaces in an automotive vehicle are consolidated into a single interface in an emotive advisory system (EAS).

An existing emotive advisory system (EAS) provides an intelligent electronic occupant interface that identifies individual occupants and learns their preferences to establish an emotional bond between the occupant and the vehicle. The interface uses synthetic speech and an avatar to communicate to the occupant and speech recognition, vision and conventional controls to receive information from the occupant. The interface provides a message-oriented middleware interface that provides a backbone for software agents to interact with the EAS, vehicle systems and the Internet.

Background information may be found in U.S. Pub. No. 2008/0269958.

### SUMMARY

In one embodiment of the invention, a vehicle maintenance advisor system for use by a driver of an automotive vehicle includes a computer. The computer is configured to receive input indicative of a vehicle history. The vehicle history includes how the vehicle is driven over time. The computer is further configured to identify a need to advise the driver that the vehicle requires a maintenance service based on the vehicle history. An alert is output to the driver. The alert indicates the required maintenance service for the vehicle.

At the more detailed level, the invention comprehends a variety of features that may be implemented individually or in appropriate combinations depending on the application. In one aspect of the invention, the computer is further configured to provide a natural language interface for communication with the driver. In another aspect of the invention, the computer may identify the driver, and determine an appropriate way to output the alert to the driver based on learned driver preferences. As well, the computer may, over time, learn and store driver preferences for the alert. Further, the computer may determine context information, and determine an appropriate way to output the alert to the driver based on the context information.

It is appreciated that the required maintenance service for the vehicle may be specific to the history of that particular vehicle. The required maintenance service for the vehicle may be required at a time that is earlier than a standard service interval, or at a time that is later than a standard service interval.

The system may also provide the capability for resetting the service reminder once a specific service action has been completed. In more detail, the computer may receive input indicative of a service reminder reset representing that the required maintenance service has been performed, and store an indication of the service reminder reset in the vehicle history such that the vehicle history indicates that the required maintenance service has been performed. Vehicle history may also include what was done, cost, satisfaction, where the work was done, by whom, driver/owner impression of experience, and parts used. Maintenance records are searchable in the event of repeated problems, etc. For example, if the interval between brake pad replacements gets shorter there may be a problem with the brake calipers. Vehicle history may also include original or service warranty information. For example, the vehicle history may determine if a required service falls under the original warranty. For example, if a required service is related to previously performed service, the vehicle history may determine if the required service falls under a service warranty for the previously performed service.

The system may also offer the driver the ability to identify a service facility by outputting location information for a vehicle service center. The system may draw upon learned driver preferences when suggesting a service facility.

The system may also output or offer recommendations to the driver of how to drive the vehicle over time with the goal of reducing maintenance service costs. These recommendations are based on the vehicle history. Recommendations or reminders may be given verbally, or could be sent in the form of email or SMS messages. As well, the system may predict when the vehicle will require a maintenance service based on the vehicle history, and output an advanced warning to the driver.

The vehicle history may include a variety of information. For example, in some embodiments, the vehicle history includes driving history information and weather history information. The computer may also be configured to receive input from one or more vehicle systems, these inputs indicating at least part of the vehicle history.

Embodiments of the invention may be utilized for a variety of vehicle maintenance items; for example, engine oil service or transmission fluid service.

In another aspect of the invention, the computer is further configured to generate (i) data representing an avatar having an appearance and (ii) data representing a spoken statement for the avatar. The spoken statement provides the alert to the driver in spoken dialog. In turn, the computer outputs the data representing the avatar for visual display, and outputs the data representing the statement for the avatar for audio play.

At the more detailed level, the computer may receive input, in the form of spoken dialog, indicative of a driver request to provide required maintenance service information to the driver. The system may respond with a spoken statement which provides required maintenance service information to the driver in spoken dialog based on the driver request. The system may also respond by transmitting the information to an in-vehicle display or to a portable user device or even to the Internet for later use by the owner/driver.

### BRIEF DESCRIPTION OF THE DRAWINGS

FIG. 1 is a block diagram of an emotive advisory system for an automotive vehicle, in one embodiment;

FIG. 2 illustrates a block diagram of an emotive advisory system for an automotive vehicle, in one embodiment, at a more detailed level; and

FIGS. 3-13 are block diagrams illustrating various features which may be present in embodiments of the invention.

### DETAILED DESCRIPTION

Embodiments of the invention comprehend an emotive advisory system (EAS) for use by one or more occupants of an automotive vehicle. In one approach to implementing the system, various vehicle interfaces in the automotive vehicle are consolidated into a single interface in the emotive advisory system (EAS).

In general, the emotive advisory system (EAS) for the automotive vehicle emotively conveys information to an occupant. The system receives input indicative of an operating state of the vehicle, transforms the input into data representing a simulated emotional state and generates data representing an avatar that expresses the simulated emotional state. The avatar may be displayed. The system may receive a query from the occupant regarding the emotional state of the avatar, and respond to the query. An example emotive advisory system and method is described in U.S. Pub. No. 2008/0269958.

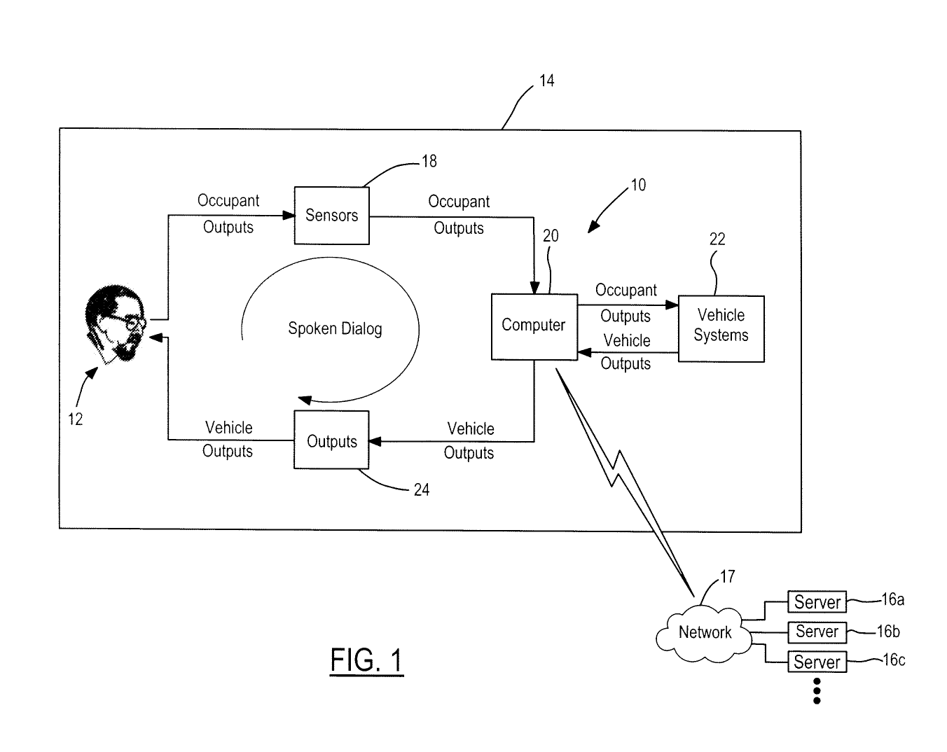

As shown in FIG. 1, an embodiment of an emotive advisory system (EAS) 10 assists an occupant/user 12 of a vehicle 14 in operating the vehicle 14 and in accessing information sources 16a, 16b, 16c, for example, web servers, etc., remote from the vehicle 14 via a network 17. Of course, other embodiments of the EAS 10 may be implemented within the context of any type of device and/or machine. For example, the EAS 10 may accompany a household appliance, handheld computing device, etc. Certain embodiments of the EAS 10 may be implemented as an integrated module that may be docked with another device and/or machine. A user may thus carry their EAS 10 with them and use it to interface with devices and/or machines they wish to interact with. Other configurations and arrangements are also possible.

In the embodiment of FIG. 1, sensors 18 detect inputs generated by the occupant 12 and convert them into digital information for a computer 20. The computer 20 receives these inputs as well as inputs from the information sources 16a, 16b, 16c and vehicle systems 22. The computer 20 processes these inputs and generates outputs for at least one of the occupant 12, information sources 16a, 16b, 16c and vehicle systems 22. Actuators/outputs, etc. 24 convert the outputs for the occupant 12 from a digital format into a format that may be perceived by the occupant 12, whether visual, audible, tactile, haptic, etc.

The occupant 12 may, in some embodiments, communicate with the EAS 10 through spoken dialog that follows rules of discourse (for example, Grice's maxims). For example, the occupant 12 may ask “Are there any good restaurants in the area?” In response, the EAS 10 may query appropriate information sources 16a, 16b, 16c and, together with geographic location information from the vehicle systems 22, determine a list of highly rated restaurants near the current location of the vehicle 14. The EAS 10 may answer with the simulated dialog: “There are a few. Would you like to hear the list?” An affirmative response from the occupant 12 may cause the EAS 10 to read the list.

The occupant 12 may also command the EAS 10 to alter certain parameters associated with the vehicle systems 22. For example, the occupant 12 may state “I feel like driving fast today.” In response, the EAS 10 may ask “Would you like the drivetrain optimized for performance driving?” An affirmative response from the occupant 12 may cause the EAS 10 to alter engine tuning parameters for enhanced performance.

In some embodiments, the spoken dialog with the EAS 10 may be initiated without pressing any buttons or otherwise physically providing input to the EAS 10. This open microphone functionality allows the occupant 12 to initiate a conversation with the EAS 10 in the same way the occupant 12 would initiate a conversation with another occupant of the vehicle 14.

The occupant 12 may also “barge in” on the EAS 10 while it is speaking. For example, while the EAS 10 is reading the list of restaurants mentioned above, the occupant 12 may interject “Tell me more about restaurant X.” In response, the EAS 10 may cease reading the list and query appropriate information sources 16a, 16b, 16c to gather additional information regarding restaurant X. The EAS 10 may then read the additional information to the occupant 12.

In some embodiments, the actuators/outputs 24 include a screen that selectively displays an avatar. The avatar may be a graphical representation of human, animal, machine, plant, vehicle, etc. and may include features, for example, a face, etc., that are capable of visually conveying emotion. The avatar may be hidden from view if, for example, a speed of the vehicle 14 is greater than a threshold which may be manufacturer or user defined. The avatar's voice, however, may continue to be heard. Of course, any suitable type of display technology, such as a holographic or head-up display, may be used.

The avatar's simulated human emotional state may depend on a variety of different criteria including an estimated emotional state of the occupant 12, a condition of the vehicle 14 and/or a quality with which the EAS 10 is performing a task, etc. For example, the sensors 18 may detect head movements, speech prosody, biometric information, etc. of the occupant 12 that, when processed by the computer 20, indicate that the occupant 12 is angry. In one example response, the EAS 10 may limit or discontinue dialog that it initiates with the occupant 12 while the occupant 12 is angry. In another example response, the avatar may be rendered in blue color tones with a concerned facial expression and ask in a calm voice “Is something bothering you?” If the occupant 12 responds by saying “Because of this traffic, I think I'm going to be late for work,” the avatar may ask “Would you like me to find a faster route?” or “Is there someone you would like me to call?” If the occupant 12 responds by saying “No. This is the only way . . . ,” the avatar may ask “Would you like to hear some classical music?” The occupant 12 may answer “No. But could you tell me about the upcoming elections?” In response, the EAS 10 may query the appropriate information sources 16a, 16b, 16c to gather the current news regarding the elections. During the query, if the communication link with the information sources 16a, 16b, 16c is strong, the avatar may appear happy. If, however, the communication link with the information sources 16a, 16b, 16c is weak, the avatar may appear sad, prompting the occupant to ask “Are you having difficulty getting news on the elections?” The avatar may answer “Yes, I'm having trouble establishing a remote communication link.”

During the above exchange, the avatar may appear to become frustrated if, for example, the vehicle 14 experiences frequent acceleration and deceleration or otherwise harsh handling. This change in simulated emotion may prompt the occupant 14 to ask “What's wrong?” The avatar may answer “Your driving is hurting my fuel efficiency and reducing transmission life. You might want to cut down on the frequent acceleration and deceleration.” The avatar may also appear to become confused if, for example, the avatar does not understand a command or query from the occupant 12. This type of dialog may continue with the avatar dynamically altering its simulated emotional state via its appearance, expression, tone of voice, word choice, etc. to convey information to the occupant 12.

The EAS 10 may also learn to anticipate requests, commands and/or preferences of the occupant 12 based on a history of interaction between the occupant 12 and the EAS 10. For example, the EAS 10 may learn that the occupant 12 prefers a cabin temperature of 72° Fahrenheit when ambient temperatures exceed 80° Fahrenheit and a cabin temperature of 78° Fahrenheit when ambient temperatures are less than 40° Fahrenheit and it is a cloudy day. A record of such climate control settings and ambient temperatures may inform the EAS 10 as to this apparent preference of the occupant 12. Similarly, the EAS 10 may learn that the occupant 12 prefers to listen to local traffic reports upon vehicle start-up. A record of several requests for traffic news following vehicle start-up may prompt the EAS 10 to gather such information upon vehicle start-up and ask the occupant 12 whether they would like to hear the local traffic. Other learned behaviors are also possible.

These learned requests, commands and/or preferences may be supplemented and/or initialized with occupant-defined criteria. For example, the occupant 12 may inform the EAS 10 that they do not like to discuss sports but do like to discuss music, etc. In this example, the EAS 10 may refrain from initiating conversations with the occupant 12 regarding sports but periodically talk with the occupant 12 about music.

It is appreciated that an emotive advisory system (EAS) may be implemented in a variety of ways, and that the description herein is exemplary. Further more detailed description of an example emotive advisory system is provided in U.S. Pub. No. 2008/0269958. In general, with continuing reference to FIG. 1, computer 20 communicates with information sources 16a, 16b, 16c, and communicates with various peripheral devices such as buttons, a video camera, a vehicle bus controller, a sound device and a private vehicle network. The computer 20 also communicates with a display on which the avatar may be rendered. Other configurations and arrangements are, of course, also possible.

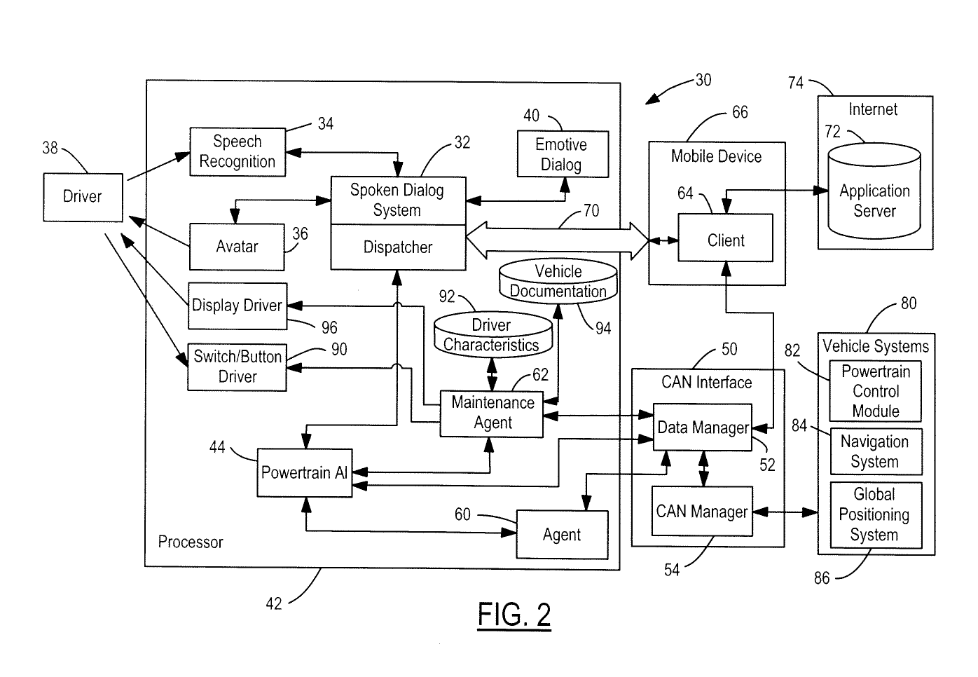

FIG. 2 illustrates a block diagram of an emotive advisory system (EAS) 30 for an automotive vehicle, in an example embodiment. EAS 30 is illustrated at a more detailed level, and may operate generally in the same manner described above for EAS 10 of FIG. 1. As shown, spoken dialog system/dispatcher 32 communicates with speech recognition component 34 and avatar component 36, which interface with the driver 38. As well, spoken dialog system/dispatcher 32 also communicates with emotive dialog component 40. Various components of EAS 30 are implemented at processor 42. Processor 42 may take the form of any suitable device as appreciated by those skilled in the art. For example, processor 42 may be implemented as a control module on the vehicle. In more detail, powertrain AI 44 communicates with spoken dialog system/dispatcher 32, and with Controller Area Network (CAN) interface 50, which is composed of data manager 52 and CAN manager 54. CAN is an embedded network currently used in vehicles. Other implementations are possible.

Middleware links EAS 30 with one or more software agents 60, including maintenance agent 62. In general, a software agent may be an independent program that interacts with the EAS 30 illustrated in FIG. 2 (or EAS 10 of FIG. 1) to implement specific tasks/functions. For example, an agent implements a specific task or function, and may utilize the spoken dialog system/dispatcher 32 and other system components to interact with the driver 38.

A software agent may be configured to receive a variety of inputs. The agent may process these inputs, provide a variety of outputs and perform its designated task(s) in accordance with the inputs. The agent may also process vehicle system outputs. The agent may also output an emotional output, for presentation by avatar 36, that is an indicator of how well the agent is performing its intended function.

In accordance with the illustrated embodiment of the invention, a maintenance advisor is implemented as an EAS agent, maintenance agent 62. EAS system 30 allows the maintenance advisor to interact with the driver 38 via spoken dialog.

With continuing reference to FIG. 2, a client 64 may be implemented on a mobile device 66. Mobile device 66 may take the form of any suitable device as is appreciated by those skilled in the art, and communicates over link 70 with the spoken dialog system/dispatcher 32. For example, mobile device 66 may take the form of a mobile telephone or PDA. In one implementation, ARM Hardware (ARM Holdings, Cambridge, England, UK) and Windows Mobile operating system (Microsoft Corporation, Redmond, Wash.) are used. Client 64 communicates with application server 72, which is shown located on the Internet 74.

With continuing reference to FIG. 2, EAS 30 is also in communication with various vehicle systems 80 including, for example, powertrain control module 82, navigation system 84, and global positioning system 86, via the CAN interface 50.

It is appreciated that EAS 10, EAS 30, software maintenance agent 62, and other illustrated systems and components are only examples, and various implementations of the invention are possible.

In the example embodiment shown in FIG. 2, maintenance agent 62 and vehicle system software compose a maintenance minder system that extends the capabilities of EAS 30. By using EAS 30, it is possible to directly determine the occupant preferences, intentions and observations, and enable EAS 30 to remember how the vehicle is driven over time, the environmental conditions in which it was driven, the history of significant on-vehicle parameters (for example, many short trips during cold weather may lead to water accumulation thus degrading oil quality). Based on the vehicle usage history, it then becomes possible for the vehicle to recommend to the driver when and what service is recommended. Note that this may be implemented with model-based component life models that go beyond the capabilities of maintenance schedules. Maintenance schedules are typically conservative because they are based on worst-case scenarios. Model-based life models are more accurate, and therefore save money and time, and are more credible to the owner/driver.

In more detail in the example embodiment, EAS 30 may detect the driver as the vehicle is entered first because the door is opened and then by the weight and size of the driver from the occupant classification system (OCS). This gives a low accuracy identification of the driver, and prompts EAS 30 to use its video camera for face recognition to improve the recognition of the driver. This information is used to narrow the search for an EAS character which fits the OCS and face recognition identification. It is appreciated that any suitable technique may be used to identify the driver. For example, the driver could be identified by their mobile device, or some other form of electronic personal identification. EAS 30 uses a conversational dialog system that remembers places a driver has been, their driving style and driving preferences, the contexts of previous conversations, where certain events the driver witnessed took place, the communication style of the driver and functions the driver likes to have done automatically.

EAS 30 also has an avatar 36 whose appearance and persona may be adapted to the driver's preference through a number of learning techniques, and may enforce certain restrictions on different drivers based on the owner's preferences. Preferences may be set through a spoken dialog or learned from previous EAS experiences. All of these factors are stored in the EAS character for a particular driver, and enhance the driver's experience because EAS 30 is customized for each driver. EAS 30 uses a digital video camera and an automatic speech recognition (ASR) system to determine the syntax, speech prosody, physical characteristics and emotions of a driver. From these inputs the system is able to anticipate how a driver will respond to a particular stimulus, the full meaning of the driver's speech and the emotional state of the driver. Simple adaptations to this system allow the system to automatically recognize a driver and immediately instantiate the driver's EAS character.

The EAS ASR is intended to work with any voice without training. It does this by using a phonetic database that stores the pronunciation of individual sounds by features, for example by using the linear predictive method. As speech is created by the driver the database searches its list of phones and tries to associate the phones in the database with the phones the driver is speaking. The variations of the driver's speech from the phones in the database can be stored and used for low accuracy identification of the driver.

In accordance with the invention, once the driver has been identified, EAS 30 can draw upon its knowledge of the driver and their preferences together with other information sources within and external to the vehicle to intelligently offer the driver a means of being notified of the need for vehicle maintenance. Maintenance notifications are specific to the history of that vehicle and can be optimized to reduce the need for unnecessary vehicle maintenance, saving the customer money and reducing waste, but also ensuring that the driver is notified of the need for service if excessive degradation is determined earlier than the standard service interval.

EAS 30 may also provide the capability for a qualified technician or the vehicle owner to reset the service reminder once a specific service action has been completed. With all of the information available from EAS 30, it becomes important that EAS 30 delivers this information at the most appropriate time given the driver's stress, work load, or cognitive load. EAS 30 may consider traffic conditions, weather conditions, time of day, location of vehicle (from GPS), and severity of the event. That is, EAS 30 may consider all available context information when determining how and when to provide information. The system could offer the driver the ability to identify qualified service facilities (dealers or non-dealer service—potentially based on previous experience, owner or driver preferences, or on-line feedback/references of other drivers).

Embodiments of the invention have many advantages. It is appreciated that to properly maintain their vehicles owners of vehicles are given a maintenance schedule with the owners manual. Even if the owners were to read the information provided, they are often left to determine if their vehicle usage patterns qualify as “normal,” severe duty or light duty. When some replace their old vehicles with new ones, it is possible that they will continue following the old maintenance guidelines with their new vehicles, even though requirements may have changed.

Embodiments of the invention may implement one or more functions related to maintenance advising. In a first function, EAS 30 has the capability to interact with the driver in a conversational approach allowing it to more clearly explain the vehicle needs and answer questions of the vehicle owner/driver.

In a second function, EAS 30 offers the ability to offer the information available in the owners manuals and maintenance schedule (and even the service manuals) to the driver in a way that corresponds to the driver's preferences. In more detail, EAS 30 has the capability to observe how the vehicle is driven over time, and based on the cumulative behavior to directly advise the driver on what service is required. EAS 30 may remind the driver about upcoming recommended maintenance. EAS 30 may provide recommendations on local service providers (dealer and non-dealer). EAS 30 could also provide the ability to assist the driver in scheduling the service if desired, provide specifications and capacities, and provide part numbers. Scheduling can be adjusted based on driver's preference on consolidating individual maintenance items that may be due in an approximate timeframe or location.

In a third function, components monitored for service life could include (not a comprehensive list): tires (based on number of miles driven, and observed operating pressures and environmental conditions), engine oil and filter, fuel and air filters, transmission fluids, power steering, brakes, belt life, engine coolant, or which service interval is approaching.

The vehicle maintenance advisor may receive information from a variety of sources. The following inputs are one possibility: driver input via reconfigurable or fixed switch/button (switch/button driver 90), spoken dialog system 32, CAN bus (data manager 52), driver characteristics database 92, and vehicle documentation database 94.

For driver input via switch/button, the driver could press an information (or help) button which would allow them to then request information from the dialog system in response to some driver observed behavior or event. For example, the driver hears a noise and asks “What was that noise? Is everything alright?”.

For the spoken dialog system 32, the driver could request information on a fault, or general information about the vehicle as well. The spoken dialog system 32 could notify the driver of the presence of the condition and ask the driver if they would like to receive any additional information on the condition from the situation. As well, EAS 30 may communicate the severity of the condition to the driver.

The driver can be asked to make observations that may be used by EAS to aid diagnosis, and may also volunteer observations. These will be recorded in the vehicle maintenance history. The driver may be able to address EAS maintenance concerns such as “Do you hear a noise that sounds like this?”; “Please put a penny in the tire tread, does the tread reach Lincoln's hair?”. Messages can be delivered at appropriate times, for example, low tire pressure or low oil level is delivered at a service station or a parts store.

For the CAN bus, detection of certain conditions results in broadcast of a warning message. Information about the fault can be gathered by EAS 30 and; prioritized per severity of the maintenance requirement, categorized per system generating it, and classified per the details of the condition.

For the driver characteristics database 92, it is possible to modify dialog enhancement of the base vehicle system based on a driver's desire for more information.

For the vehicle documentation database 94, it is possible that information from owner's manuals and other vehicle service documentation can be drawn upon and provided to the driver.

The vehicle maintenance advisor may output information in a variety of ways. The following outputs are one possibility: spoken dialog system 32, driver characteristics database 92.

Regarding spoken dialog system 32, spoken dialog system 32 can provide an alert and information to the driver. Dialog presentation can vary based on severity of the existing condition. The spoken dialog system 32 may provide spoken dialog or information may be presented as written text. In one approach, an information button is illuminated and when the driver presses the button, the spoken dialog system 32 provides information to the driver.

For the driver characteristics database 92, the system could remember driver preferences for information presentation.

It is appreciated that embodiments of the invention may determine when maintenance needs to be done, based on driving history including, for example, driving history (style, road type, drive duration, HVAC usage, towing events, etc.), weather history (temperature, humidity, precipitation, road salt, altitude (from GPS/Navigation), vehicle location (near ocean for example), amount of sun, etc.), maintenance schedule, vehicle sensors, and the Internet. Weather information may come from the Internet or from vehicle system sensors. In addition, it is appreciated that EAS 30 may offer enhanced trouble code explanations, and may interpret the relationships among multiple trouble codes.

It is also appreciated that a maintenance advisory system made in accordance with the invention may provide a variety of additional advantageous functions. For example, the advisory system may be used to train the driver to reduce maintenance costs through better driving. In more detail, the system may advise the driver, at appropriate times, that; hard turns increase tire wear, low tire pressure increases tire wear, running wipers dry increases wear, driving too fast over rough surfaces increases wear, or improved routing when available. Positive reinforcement is also contemplated. For example, after the driver smoothly navigates through a turn, EAS 30 may state “That was a very graceful turn. Such graceful turns will increase the life of my tires.”

In another possibility, the system may give the driver advanced warning of maintenance events (expenses) by predicting, for example; tire life, battery end-of-life (crank voltage), washer fluid fills, steering, brake fluid, brake pad replacement, clutch wear, air filter life, engine coolant life, lamp replacement, etc. When appropriate, EAS 30 can prepare a list of parts need at the part store or the gas station. The list could be displayed on a mobile device and carried into the shop.

In another possibility, the system may encourage the driver to get maintenance done on-time. The system, over time, may learn which rhetorical devices work the best, which voice personalities work the best, the best time to suggest maintenance work be done.

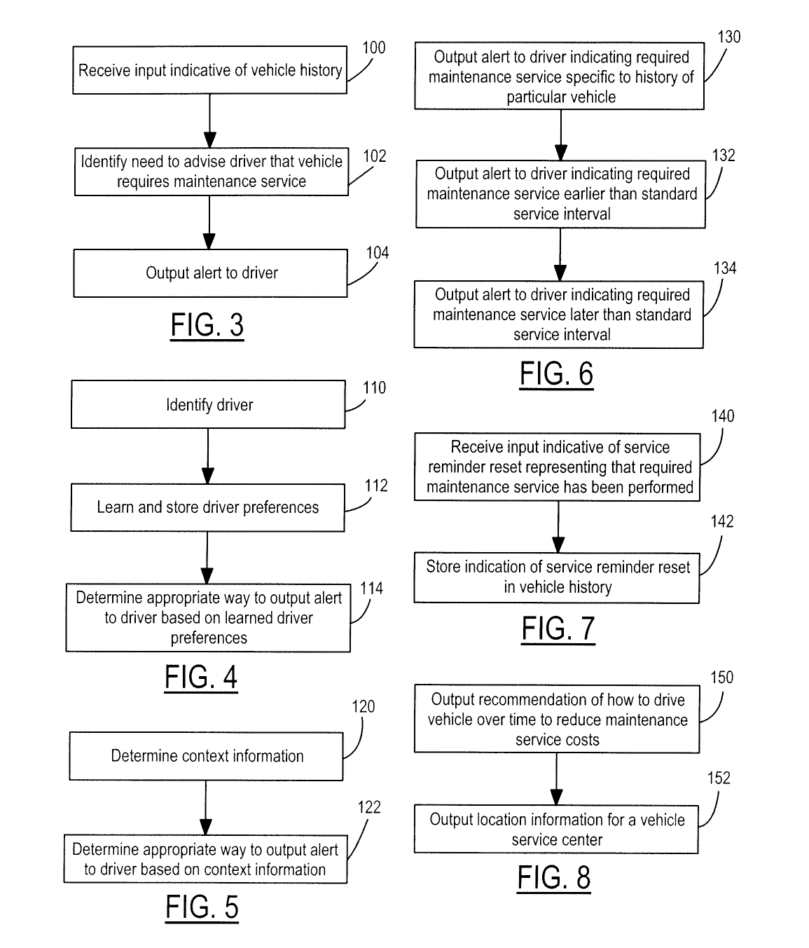

FIG. 3 illustrates operation of a vehicle maintenance advisor system. At block 100, the computer receives input indicative of a vehicle history. The vehicle history includes how the vehicle is driven over time. At block 102, the computer identifies a need to advise the driver that the vehicle requires a maintenance service based on the vehicle history. At block 104, the computer outputs an alert to the driver. The alert indicates the required maintenance service for the vehicle.

FIG. 4 illustrates consideration of driver preferences. At block 110, the computer identifies the driver. At block 112, the computer learns and stores driver preferences for an appropriate way to output the alert to the driver. At block 114, the computer determines an appropriate way to output the alert to the driver based on learned driver preferences.

FIG. 5 illustrates consideration of context information. At block 120, the computer determines context information. At block 122, the computer determines an appropriate way to output the alert to the driver based on the context information.

FIG. 6 illustrates further details relating to outputting the alert to the driver. At block 130, the computer outputs the alert to the driver. As depicted, the required maintenance service for the vehicle is specific to the history of that particular vehicle. At block 132, the computer outputs the alert to the driver, and the required maintenance service for the vehicle is required at a time that is earlier than a standard service interval. At block 134, the computer outputs the alert to the driver, and the required maintenance service for the vehicle is required at a time that is later than a standard service interval.

FIG. 7 illustrates the use of a service reminder reset. At block 140, the computer receives input indicative of a service reminder reset representing that the required maintenance service has been performed. At block 142, the computer stores an indication of the service reminder reset in the vehicle history. As such, the vehicle history indicates that the required maintenance service has been performed.

FIG. 8 illustrates further more detailed aspects of the invention in one embodiment. At block 150, the computer outputs a recommendation to the driver. The recommendation is based on the vehicle history, and indicates a recommendation of how to drive the vehicle over time to reduce maintenance service costs. At block 152, the computer outputs location information for a vehicle service center.

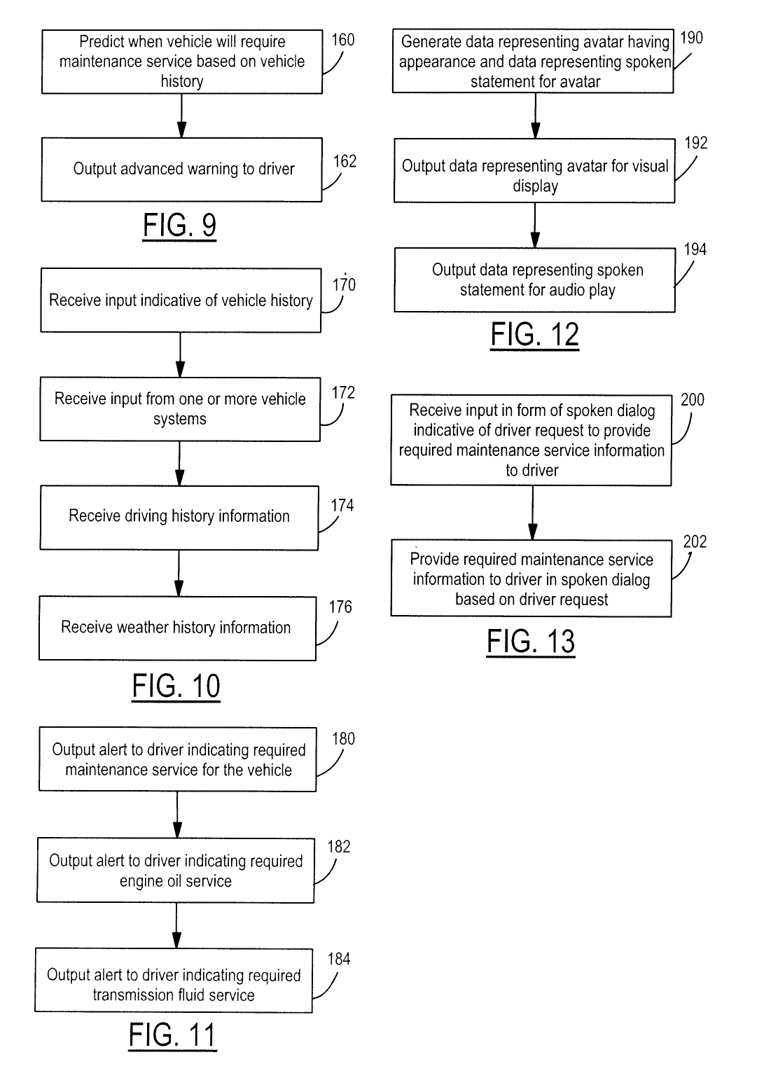

FIG. 9 illustrates maintenance service requirement prediction. At block 160, the computer predicts when the vehicle will require a maintenance service based on the vehicle history. At block 162, the computer outputs an advanced warning to the driver. The advanced warning indicates the prediction.

FIG. 10 illustrates further more detailed aspects of vehicle history in one embodiment. At block 170, the computer receives input indicative of vehicle history. At block 172, the computer receives input from one or more vehicle systems indicating at least part of the vehicle history. Block 174 depicts the computer receiving driving history information. Block 176 depicts the computer receiving weather history information.

FIG. 11 illustrates more detailed aspects of the output alert in one embodiment. At block 180, the output alert to the driver indicates required maintenance service for the vehicle. At block 182, the required maintenance service for the vehicle includes engine oil service. At block 184, the required maintenance service for the vehicle includes transmission fluid service.

FIG. 12 illustrates operation of an embodiment of the invention including an avatar. At block 190, the computer generates data representing an avatar having an appearance, and data representing a spoken statement for the avatar. The spoken statement provides the alert to the driver in spoken dialog. At block 192, the computer outputs the data representing the avatar for visual display. And at block 194, the computer outputs the data representing the statement for the avatar for audio play.

FIG. 13 illustrates interactions with the spoken dialog system in one embodiment. At block 200, the computer receives input, in the form of spoken dialog, indicative of a driver request to provide required maintenance service information to the driver. Block 202 depicts the spoken statement providing required maintenance service information to the driver in spoken dialog based on the driver request

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A vehicle maintenance advisor system for use by a driver of an automotive vehicle, the system comprising:
a computer configured to:
receive input from one or more vehicle systems indicative of a vehicle history including how that particular vehicle is driven over time;
identify a need to advise the driver that the vehicle requires a maintenance service specific to the vehicle history of that particular vehicle; and
output an alert to the driver, the alert indicating the required maintenance service for the vehicle.

2. The system of claim 1 wherein the required maintenance service for the vehicle is required at a time that is earlier than a standard service interval; and
wherein the required maintenance service for the vehicle includes at least one of engine oil service and transmission fluid service.

3. A vehicle maintenance advisor system for use by a driver of an automotive vehicle, the system comprising:
a computer configured to:
receive input indicative of a vehicle history including how the vehicle is driven over time;
identify a need to advise the driver that the vehicle requires a maintenance service based on the vehicle history; and
output an alert to the driver, the alert indicating the required maintenance service for the vehicle.

4. The system of claim 3 wherein the computer is further configured to:
provide a natural language interface for communication with the driver.

5. The system of claim 3 wherein the computer is further configured to:
identify the driver; and
determine an appropriate way to output the alert to the driver based on learned driver preferences.

6. The system of claim 3 wherein the computer is further configured to:
determine context information; and
determine an appropriate way to output the alert to the driver based on the context information.

7. The system of claim 3 wherein the required maintenance service for the vehicle is specific to the history of that particular vehicle.

8. The system of claim 7 wherein the required maintenance service for the vehicle is required at a time that is earlier than a standard service interval.

9. The system of claim 7 wherein the required maintenance service for the vehicle is required at a time that is later than a standard service interval.

10. The system of claim 3 wherein the computer is further configured to:
receive input indicative of a service reminder reset representing that the required maintenance service has been performed; and
store an indication of the service reminder reset in the vehicle history such that the vehicle history indicates that the required maintenance service has been performed.

11. The system of claim 3 wherein the computer is further configured to:
output location information for a vehicle service center; and
output, based on driver preferences, a group of maintenance items due in a time window.

12. The system of claim 3 wherein the computer is further configured to:
output a recommendation to the driver, the recommendation being based on the vehicle history and indicating a recommendation of how to drive the vehicle over time to reduce maintenance service costs.

13. The system of claim 3 wherein the computer is further configured to:
predict when the vehicle will require a maintenance service based on the vehicle history; and
output an advanced warning to the driver, the advanced warning indicating the prediction.

14. The system of claim 3 wherein the vehicle history includes driving history information and weather history information, the need to advise the driver being based on the driving history information and the weather history information.

15. The system of claim 3 wherein the computer is further configured to:
receive input from one or more vehicle systems, the input indicating at least part of the vehicle history.

16. The system of claim 3 wherein the computer is further configured to:
identify the driver; and
store driver preferences for an appropriate way to output the alert to the driver.

17. The system of claim 3 wherein the required maintenance service for the vehicle includes engine oil service.

18. The system of claim 3 wherein the required maintenance service for the vehicle includes transmission fluid service.

19. The system of claim 3 wherein the computer is further configured to:
generate (i) data representing an avatar having an appearance and (ii) data representing a spoken statement for the avatar, the spoken statement providing the alert to the driver in spoken dialog;
output the data representing the avatar for visual display; and
output the data representing the statement for the avatar for audio play.

20. The system of claim 19 wherein the computer is further configured to:
receive input, in the form of spoken dialog, indicative of a driver request to provide required maintenance service information to the driver;
wherein the spoken statement provides required maintenance service information to the driver in spoken dialog based on the driver request.
